(19) United States
(12) Patent Application Publication
(10) Pub. No.: US 2009/0213404 A1
(43) Pub. Date: Aug. 27, 2009

(54) METHOD AND APPARATUS FOR POPULATING A FORM WITH INFORMATION

(76) Inventor: Ching-Feng Cheng, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/037,945

(22) Filed: Feb. 27, 2008

(51) Int. Cl. G06F 15/00; G06F 17/00

(52) U.S. Cl. 358/1.13; 715/255

(57) ABSTRACT

A method for populating form with information includes providing an image of a form, identifying at least one blank area on the image of the form, displaying the image of the form, selecting the blank area, filling the blank area with information, and mapping the information and the position of the information on the image of the form.

### BACKGROUND OF THE INVENTION

1. Field of the Invention

The present invention provides a method and an apparatus for mapping information and the position of the information on the form.

2. Description of the Prior Art

The current all-in-one multifunctional devices provide many functions for the user. However, when the user needs to transfer a large amount of information onto many forms, time and resources are generally wasted due to lack of appropriate methods. For example, when a personnel department wants to fill employee information onto a personnel form, manually filling the information for every employee wastes considerable time. In addition, if the above work is done by printing the information of employees provided from a computer database onto the personnel form, the employee information must be placed in specific positions on the personnel form. In the prior art methods and related apparatuses, however, the information is difficult to be specifically positioned and generally needs many trials. Therefore, both time and paper is wasted. As a result, how to solve the above-mentioned problems efficiently has become an important issue among manufacturers.

### SUMMARY OF THE INVENTION

It is one of the objectives of the present invention to provide a method and an apparatus for mapping information and the position of the information on the form.

The present invention discloses a method for populating a form with information, and the method comprises: providing an image of the form; identifying at least one blank area on the image of the form; displaying the image of the form; selecting the blank area; filling the blank area with information; and mapping the information and the position of the information on the image of the form.

The present invention discloses an apparatus for populating a form with information, and the apparatus comprises: a first providing unit for providing an image of the form; an identifying unit, coupled to the first providing unit, for identifying at least one blank area on the image of the form; a second providing unit for providing information; an acquisition unit, coupled to the second providing unit, for mapping the information and the position of the information on the image of the form; a display unit, coupled to the identifying unit and the acquisition unit, for displaying the image of the form and the information; a storage unit, respectively coupled to the identifying unit and the acquisition unit, for storing the information and either the position of the information on the image of the form or the image of the form; and a printing unit, coupled to the storage unit, for printing the information on the blank area of the form.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a method for populating the form with the information according to a first embodiment of the present invention.

FIG. 2 is a flowchart of a method for populating the form with the information according to a second embodiment of the present invention.

FIG. 3 is a flowchart of a method for populating the form with the information according to a third embodiment of the present invention.

FIG. 4 is a circuit block diagram of an apparatus of the present invention.

### DETAILED DESCRIPTION

### First Embodiment

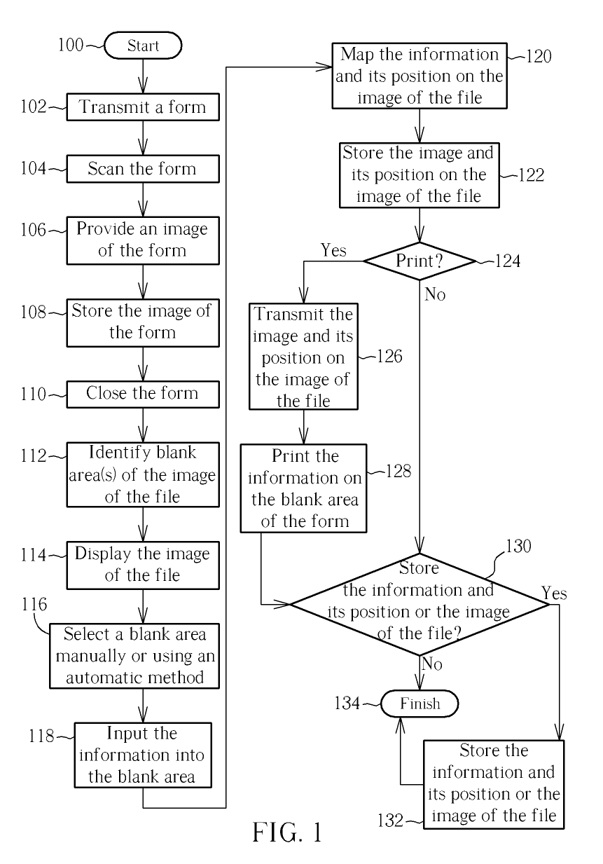

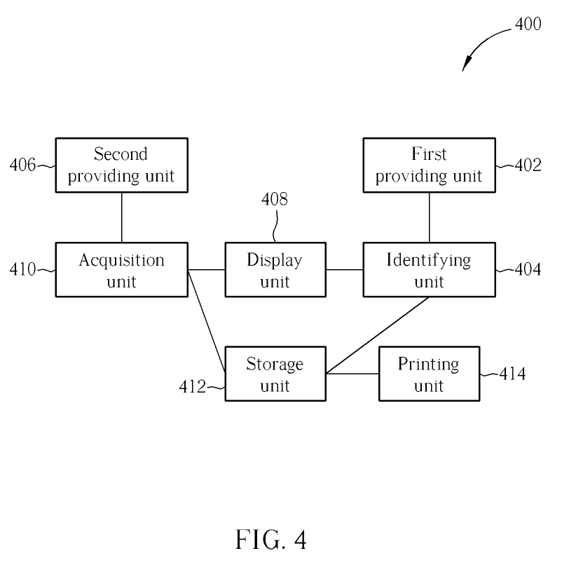

Please refer to FIG. 1 and FIG. 4. FIG. 4 is a circuit block diagram of an apparatus of the present invention. As shown in FIG. 4, the apparatus 400 comprises at least a first providing unit 402, an identifying unit 404, a second providing unit 406, an acquisition unit 410, a display unit 408, a storage unit 412 and a printing unit 414.

The first providing unit 402 is coupled to the identifying unit 404. The first providing unit 402 is utilized for providing an image of the form, and the identifying unit 404 is utilized for identifying blank area(s) of the image of the form.

The second providing unit 406 is coupled to the acquisition unit 410. The user provides information such as letters, patterns or symbols to the blank area(s) on the image of the form required by the second providing unit 406. The acquisition unit 410 then maps the information provided by the user and the position of the information on the image of the form.

The display unit 408 is respectively coupled to the identifying unit 404 and the acquisition unit 410, and is utilized for displaying the image of the form and the information.

The storage unit 412 is respectively coupled to the identifying unit 404 and the acquisition unit 410, and is utilized for storing the information and the position of the information on the image of the form or the image of the form.

Please refer to FIG. 1. FIG. 1 is a flowchart of a method for populating the form with the information according to a first embodiment of the present invention. In the beginning (Step 100), the user provides a form to the apparatus, and the apparatus transmits the form by the first providing unit 402 (Step 102). The first providing unit 402 can be a scanner, a device that can generate an image of the form or a storage device. In this embodiment, a scanner is taken as an example of the providing unit 402. The providing unit 402 scans the form (Step 104) and generates an image of the form (Step 106), at the same time, the first providing unit 402 temporally stores the image of the form into the storage unit 108 (Step 108), and the form is closed (Step 110). The identifying unit 404 identifies the blank and the non-blank area(s) of the image of the form to obtain the position of the blank area to be filled with the information (Step 112). The identifying unit 404 can identify the blank area(s) of the black-white image or the color image; in this embodiment, the form with white background serves as the example. The display unit 408 receives the signal from the identifying unit 404 and displays the scanned image of the form (Step 114). The user selects a blank area either manually or using an automatic method according to a displayed image of the form. The manual method requires the user to select an appropriate blank area from the blank areas of the image of the form by the second providing unit 406. The automatic method is that the system searches for the blank area(s) in the image of the form automatically, and when an appropriate blank area is found, the user provides an operation of the second providing unit 406, to select the blank area (Step 116). The second providing unit 406 can be a keyboard, a mouse, a device that provides a manual input function, or a storage device. In this embodiment, the keyboard is used as an example. The user uses the keyboard to input the required information into the blank area (Step 118). When the user provides the information, the information is displayed on the display unit 408. The acquisition unit 410 maps the information and its position on the image of the form (Step 120). At the same time, the acquisition unit 410 temporally stores the information and its position on the image of the form into the storage unit 412 (Step 122). Then the user determines whether the information needs to be printed or not (Step 124). When the information needs to be printed, the information and the position of the information on the image of the form are transmitted from the storage unit 412 to the printing unit 414 (Step 126), and the printing unit 414 prints the information on the selected blank area of the form (Step 128). After printing, the user determines whether the information and the position of the information on the image of the form or the image of the form need to be stored or not (Step 130). When the information does not need to be printed, the user directly determines whether the information and the position of the information on the image of the form or the image of the form needs to be stored or not (Step 130). When it needs to be stored, the information and the position of the information on the image of the form or the image of the form are stored in the storage unit 412 (Step 132), and then finish operations (Step 134). When storing is not needed, the process directly finishes the operations (Step 134). In addition, the user can add a step for storing the image of the form after the form is scanned by the first providing unit 402 according to the user's considerations; the user can also add a step for storing the information and the position of the information on the image of the form after the acquisition unit 410 temporally stores the information and the position of the information on the image of the form into the storage unit 412.

### Second Embodiment

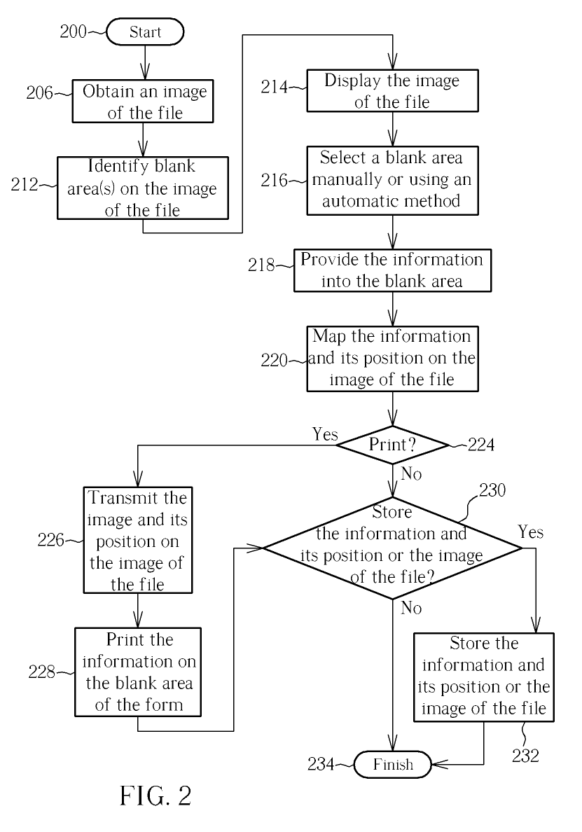

Please refer to FIG. 2 and FIG. 4. FIG. 2 is a flowchart of a method for populating the form with the information according to a second embodiment of the present invention. In the beginning (Step 200), the user obtains an image of the form by the first providing unit 402 (Step 206). The first providing unit 402 can be a scanner, a device which can generate an image of the form or a storage device. In this embodiment, a storage device is taken as an example of the providing unit 402. The user can obtain the image of the form from the storage device, where the image of the form is generated by any method and is stored in the storage device. Then the identifying unit 404 identifies the blank and non-blank area(s) of the image of the form to obtain the position of the blank area required to be filled with the information (Step 212). The identifying unit 404 can identify the blank area(s) of the black-white image or the color image; in this embodiment, the form with white background is an example. The display unit 408 receives the signal from the identifying unit 404 and displays the image of the form (Step 214). The user selects a blank area by a manual or automatic method according to a displayed image of the form (Step 216). The user provides the required information to the blank area by the second providing unit 406. The second providing unit 406 can be a keyboard, a mouse, a device that provides a manual input function, or a storage device. In this embodiment, the mouse and the storage device are as the second providing unit examples. The user can use the mouse to provide the appropriate information in the storage device to the blank area (Step 218). When the user provides the information, the information is displayed on the display unit 408. The acquisition unit 410 maps the information and the position of the information on the image of the form (Step 220). At the same time, the acquisition unit 410 temporally stores the information and the position of the information on the image of the form into the storage unit 412. Then the user determines whether the information needs to be printed or not. When the information needs to be printed, the information and its position on the image of the form are transmitted from the storage unit 412 to the printing unit 414 (Step 226). The printing unit 414 prints the information on the selected blank area of the form (Step 228). After printing, the user determines whether the information and its position or the image of the form need to be stored or not (Step 230). When the information does not need to be printed, the user directly determines whether the information and the position of the information on the image of the form or the image of the form need to be stored or not (Step 230). When it needs to be stored, the information and the position of the information on the image of the form or the image of the form are stored in the storage unit 412 (Step 232), and then the operations are completed (Step 234). When it does not need to be stored, directly complete operations (Step 234). In addition, the user can add a step of storing the image of the form after the image of the form is provided by the providing unit 402 according to the user's considerations; the user can also add a step for storing the information and the position of the information on the image of the form after the acquisition unit 410 stores the information and the position of the information on the image of the form into the storage unit 412.

### Third Embodiment

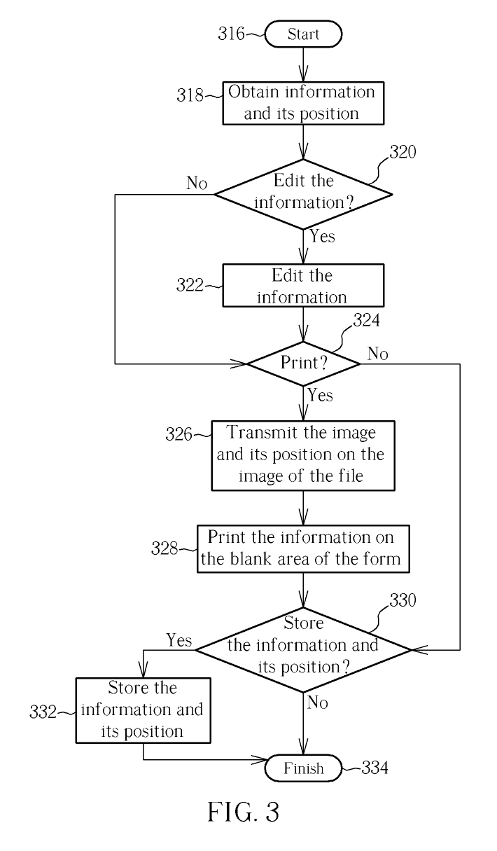

Please refer to FIG. 3 and FIG. 4. FIG. 3 is a flowchart of a method for populating the form with the information according to a third embodiment of the present invention. In the beginning (Step 316), the user obtains information and a position of the information on an image of the form from the storage unit 412 (Step 318). At the same time, the information and the position of the information on the image of the form are displayed on the display unit 408. The user determines whether the information will be edited or modified or not (Step 320). When the information needs to be edited or modified, edit or modify the information (Step 322), and then determine whether the information should be printed or not. When the information is not to be edited or modified, directly determine whether the information is to be printed or not (Step 324). When the information needs to be printed, the information and the position of the information on the image of the form are transmitted from the storage unit 412 to the printing unit 414 (Step 326). The printing unit 414 prints the information on the selected blank area of the form (Step 328). After printing, the user determines whether the information and the position of the information on the image of the form need to be stored or not (Step 330). When the information does not need to be printed, the user directly determines whether the information and the position of the information on the image of the form or the image of the form need to be stored or not (Step 330). When it needs to be stored, the information and the position of the information on the image of the form are stored in the storage unit 412 (Step 332), and then the operations are finished (Step 334). When the information and position do not need to be stored, directly finish the operations (Step 334). In this embodiment, the user can also obtain the image of the form while obtaining the information and a position of the information on the image of the form, and identify the position of the blank area(s) on the image of the form by the identifying unit 404. When the user adds information in a new blank area, the acquisition unit 410 will map the added information and the position of the information onto the image of the form. Then the user can store the added information, the original information and the positions of the added and original information on the image of the form into the storage unit 412 and/or transmit them to the printing unit 414 to be printed.

The above-mentioned embodiments are the preferred embodiments of the present invention. The modifications and the alternations of the claims of the present invention should be in the scope of the present invention.

Those skilled in the art will readily observe that numerous modifications and alterations of the device and method may be made while retaining the teachings of the invention.

What is claimed is:

1. A method for populating a form with information, comprising:
providing an image of the form;
identifying at least one blank area on the image of the form;
displaying the image of the form;
selecting the blank area;
filling the blank area with information; and
mapping the information and the position of the information on the image of the form.

2. The method of claim 1, wherein before the step of providing the image of the form, the method further comprises:
scanning the form.

3. The method of claim 1, wherein the step of providing the image of the form comprises:
obtaining the image of the form from a storage device.

4. The method of claim 1, wherein after the step of mapping the information and the position of the information on the image of the form, the method further comprises:
determining whether the information needs to be printed or not, and when the information needs to be printed, printing the information on the blank area of the form.

5. The method of claim 1, wherein after the step of mapping the information and the position of the information on the image of the form, the method further comprises:
determining whether the information and the position of the information on the image of the form or the image of the form need to be stored or not, and when yes, storing the information and the position of the information on the image of the form or the image of the form, and when no, finishing the operations.

6. An apparatus for populating a form with information, comprising:
a first providing unit, for providing an image of the form;
an identifying unit, coupled to the first providing unit, for identifying at least one blank area on the image of the form;
a second providing unit, for providing information;
a display unit, coupled to the identifying unit, for displaying the image of the form and the information;
an acquisition unit, respectively coupled to the second providing unit and the display unit, for mapping the information and the position of the information on the image of the form;
a storage unit, respectively coupled to the identifying unit and the acquisition unit, for storing the image of the form, the information, and the position of the information on the image of the form; and
a printing unit, coupled to the storage unit, for printing the information on the form.

7. The apparatus of claim 6, wherein the first providing unit is a scanner.

8. The apparatus of claim 6, wherein the second providing unit is a keyboard or a mouse.
